(19) United States
(12) Patent Application Publication
(10) Pub. No.: US 2009/0163056 A1
(43) Pub. Date: Jun. 25, 2009

(54) Light fixture and sleeve candlestick adapter

(76) Inventors: Walter Brookins, Dallas, TX (US); Todd Teiber, Plano, TX (US); Roger Priest, Aubrey, TX (US)

Correspondence Address: BRACEWELL & GIULIANI LLP, P.O. BOX 61389, HOUSTON, TX, 77208-1389, US

(21) Appl. No.: 12/004,725

(22) Filed: Dec. 21, 2007

(51) Int. Cl. H01R 13/46; F21V 19/00; H01R 13/00

(52) U.S. Cl. 439/123; 362/392; 439/124

(57) ABSTRACT

A light fixture comprises a socket having a set of internal threads for threadably engaging a light unit, the socket having a set of external threads, and a sleeve adapter configured to resemble a candlestick, the sleeve adapter disposable over the socket and configured to removably engage the set of external threads to secure the sleeve adapter thereto.

### BACKGROUND

There are a variety of types of light fixtures that are employed with ceiling fans, wall-mounted assemblies, ceiling-mounted assemblies, and the like. Some of these light fixtures employ a socket for receiving an electric-powered light bulb therein. However, although the light fixture may be acceptable for some consumers and/or occasions, changes to the light fixture to accommodate a particular occasion or to meet a particular appearance may be costly or even impossible without a complete replacement of the light fixture and/or assembly to which the light fixture is attached.

### BRIEF DESCRIPTION OF THE DRAWINGS

FIG. 1A is a diagram illustrating a light fixture in which an embodiment of a sleeve candlestick adapter is used to advantage;

FIG. 1B is a diagram partially in section illustrating the light fixture and sleeve candlestick adapter of FIG. 1A;

FIG. 1C is a diagram illustrating an exploded view of the light fixture and sleeve candlestick adapter of FIGS. 1A and 1B;

FIG. 2 is a diagram illustrating a light fixture in which an embodiment of a sleeve candlestick adapter is used to advantage; and

FIG. 3 is a diagram illustrating a light fixture in which an embodiment of a sleeve candlestick adapter is used to advantage.

### DETAILED DESCRIPTION OF THE DRAWINGS

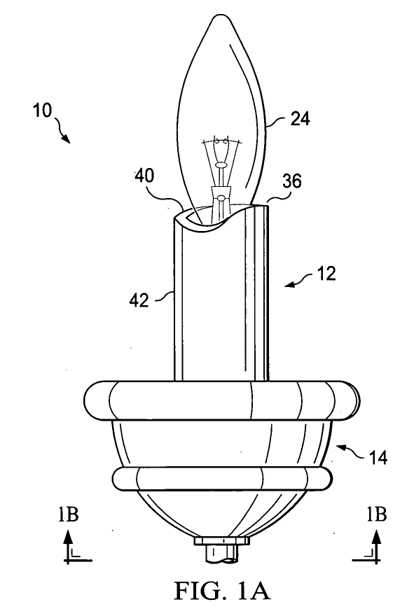

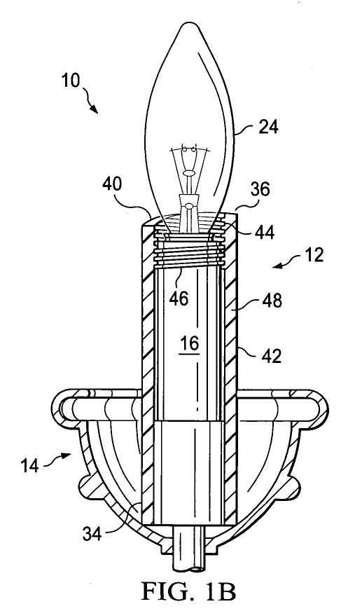

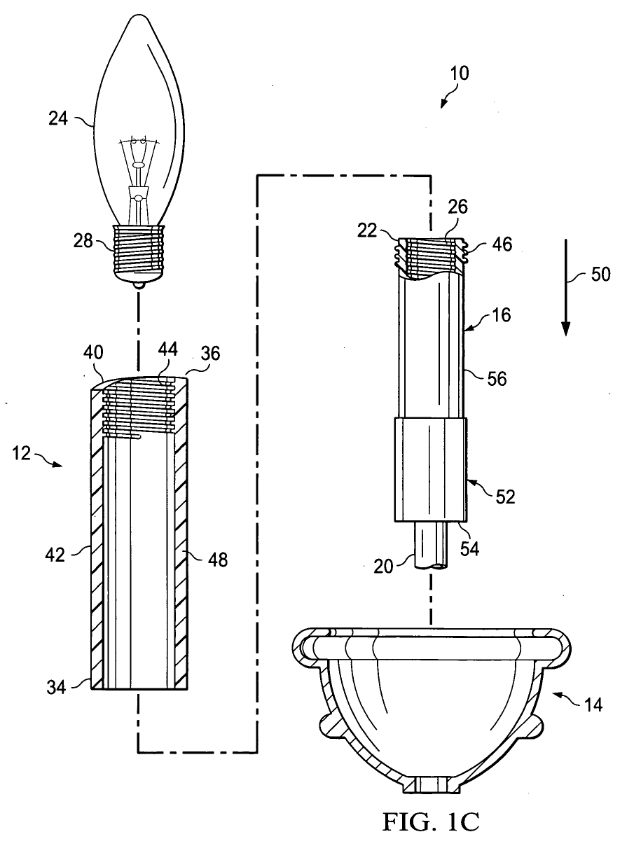

The preferred embodiments and the advantages thereof are best understood by referring to FIGS. 1A-3 of the drawings, like numerals being used for like and corresponding parts of the various drawings.

FIGS. 1A-1C are diagrams illustrating a light fixture in which an embodiment of a sleeve candlestick adapter 12 is employed to advantage. Light fixture 10 may comprise, form and/or otherwise be part of any type of lighting assembly such as, but not limited to, a ceiling fan, wall-mounted assembly, ceiling-mounted assembly, etc. In the embodiment illustrated in FIGS. 1A-1C, light fixture 10 comprises a base member 14 having a socket 16 extending upwardly therefrom. Base member 14 may comprise any type and/or shape of support member for supporting socket 16 and/or supporting other elements of light fixture 10 such as, but not limited to, a glass or decorative cover. In FIGS. 1A-1C, socket 16 comprises an end 20 mounted and/or otherwise secured to a lower portion of base member 14, and an end 22 configured for receiving releasable engagement of a light unit 24 therewith. For example, in the embodiment illustrated in FIGS. 1A-1C, end 22 of socket 16 comprises a set of internal threads 26 for releaseably and/or threadably engaging a set of external threads 28 disposed on light unit 24. Light unit 24 may comprise any type of lighting element such as, but not limited to, an incandescent light bulb, a compact fluorescent light bulb, a light emitting diode (LED)-based unit, etc., such that end 22 socket 16 is correspondingly configured to enable electrical engagement with the particular type of light unit 24.

In the embodiment illustrated in FIGS. 1A-1C, sleeve adapter 12 is configured to resemble a candlestick. For example, in FIGS. 1A-1C, sleeve adapter 12 comprises ends 34 and 36, and sleeve adapter 12 comprises a scalloped trim 40 formed at end 36 of sleeve adapter 12 to resemble a partially burned candlestick. It should be understood that sleeve adapter 12 may be otherwise configured to resemble a candlestick such as, but not limited to, wax drippings disposed on an exterior surface 42 thereof, various colors and/or color patterns/designs, etc. In operation, sleeve adapter 12 is disposable over socket 16 to provide a desired appearance of light fixture 10 (e.g., a candlestick appearance). For example, in the embodiment illustrated in FIGS. 1A-1C, sleeve adapter 12 comprises a set of internal threads 44 configured to releaseably and/or threadably engage a set of external threads 46 disposed on socket 16.

In some embodiments, sleeve adapter 12 comprises a hollow, cylindrical housing 48 that is slideable over socket 16 such that at least a portion of socket 16 is disposed within an interior area of sleeve adapter 12 when sleeve adapter 12 is attached to light fixture 10. In some embodiments, for example, sleeve adapter 12 is disposed over and/or otherwise slid downwardly over socket 16 in the direction indicated by arrow 50 such that end 34 is placed over end 22 of socket 16 and slid downwardly over socket 16 until threads 44 are in a position to engage corresponding threads 46 of socket 16. Sleeve adapter 12 may then be rotated in a corresponding direction to threadably and/or releasably engage threads 44 with threads 46, thereby securing sleeve adapter 12 to socket 16. Light unit 24 may be installed in socket 16 before or after sleeve adapter 12 engagement and/position on light fixture 10.

In the embodiment illustrated in FIGS. 1A-1C, threads 44 are disposed near end 36 of sleeve adapter 12 to correspondingly engage threads 46 disposed near end 22 of socket 16. However, it should be understood that the position and/or location of threads 44 and/or 46 may be otherwise varied (e.g., at a different location along a longitudinal length of socket 16 and/or sleeve adapter 12). It should also be understood that other types of engagement methods may be used to secure sleeve adapter 12 to light unit 10. For example, in some embodiments, sleeve adapter 12 may be secured to socket 16 and/or another portion of light fixture 10 using a snap-fit mechanism, spring-based clips, press-fit arrangement, or other type of mechanism to enable releasable engagement of sleeve adapter 12 to light fixture 10. In FIGS. 1A-1C, sleeve adapter 12 comprises a cylindrical shape; however, it should be understood that the shape of sleeve adapter 12 may be otherwise configured (e.g., having a cylindrical inside diameter to correspond with a cylindrical socket 16 but having a non-cylindrical exterior (such as square, elliptical, etc.) to provide a variety of different candlestick appearances).

In operation, sleeve adapter 12 is removable from light fixture 10 by rotating in a direction to threadably disengage threads 44 from threads 46 and sliding sleeve adapter 12 upwardly in the direction opposite that of arrow 50 until sleeve adapter 12 is removed from light fixture 10. In the embodiment illustrated in FIGS. 1A-1C, sleeve adapter 12 is removable from socket 16 and/or light fixture 10 while socket 16 remains fixedly secured to light fixture 10 (e.g., secured to base member 14). Thus, sleeve adapter 12 enables ready attachment to and removal from light fixture 10 without requiring disassembly of other portions of light fixture 10.

Referring to FIGS. 1B and 1C, in some embodiments, socket 16 comprises a stabilizer portion 52 to stabilize sleeve adapter 12 when disposed over socket 16. For example, in the embodiment illustrated in FIGS. 1B and 1B, stabilizer portion 52 comprises an extended wall portion 54 having an outer dimension and/or outer diameter greater than an outer dimension and/or outer diameter of wall portion 56 of sleeve adapter 16. In some embodiments, the outer dimension of stabilizer portion 52 corresponds to the outer dimension and/or outer diameter of threads 46.

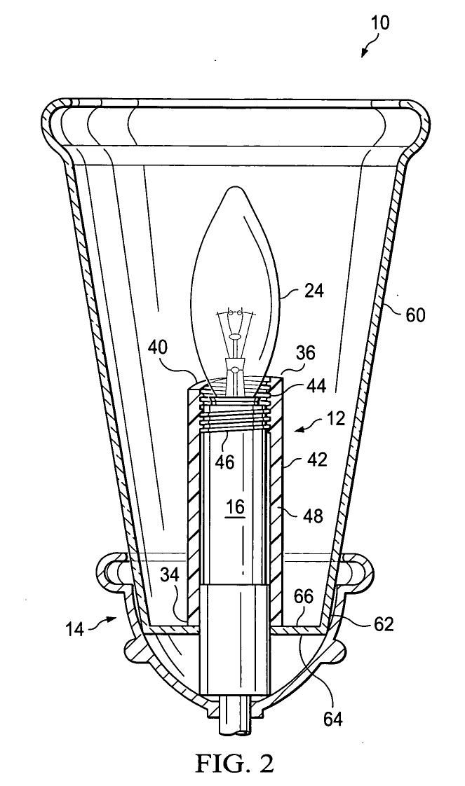

FIG. 2 is a diagram illustrating light fixture 10 having a cover 60 coupled thereto. In the embodiment illustrated in FIG. 2, cover 60 is disposed over at least a portion of socket 16 such that an end portion of 62 is received within and/or otherwise located proximate to base member 14. In FIG. 2, sleeve adapter 12 is configured to retain cover 60 on light fixture 10. For example, in the embodiment illustrated in FIG. 2, an end 64 of cover 60 is disposed and/or slid downwardly over socket 16 until end 64 is located in a seated position within base member 14. Sleeve adapter 12 is then inserted over socket 16 and is releasably secured to socket 16 (e.g., as indicated above and described relative to FIGS. 1A-1C). In the embodiment illustrated in FIG. 2, sleeve adapter 12 is configured and/or otherwise sized such that end 34 is located and/or otherwise seated against an interior surface 66 of cover 60 such that when sleeve adapter 12 is threadably secured to socket 16, end 34 prevents upward movement of cover 60, thereby securing cover 60 to base member 14.

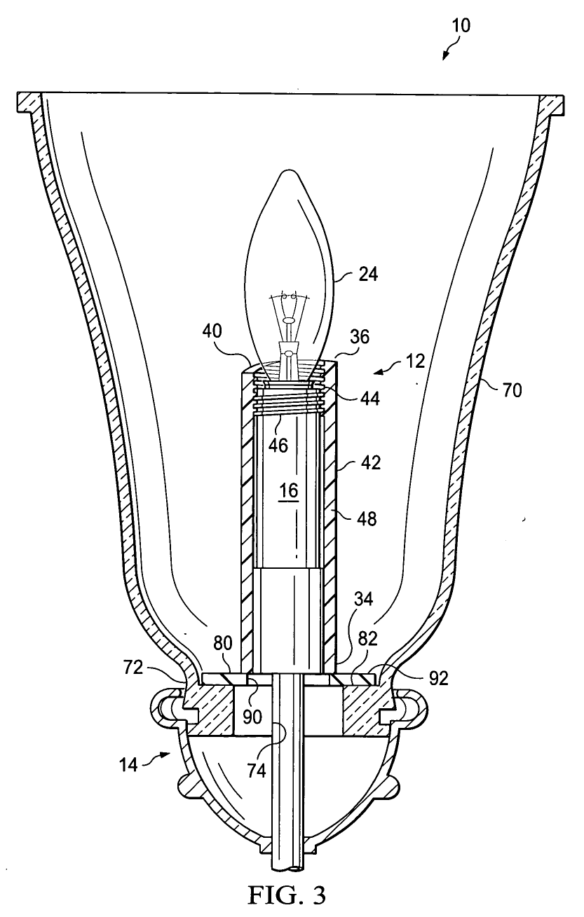

FIG. 3 is a diagram illustrating light fixture 10 having a cover 70 coupled thereto. In the embodiment illustrated in FIG. 3, cover 70 comprises an end 72 that is positionable and/or locatable within base member 14. In the embodiment illustrated in FIG. 3, end 72 of cover 70 comprises an opening 74 that is slideable over socket 16 to enable placement of cover 70 on light fixture 10 and/or base member 14. In FIG. 3, opening 74 comprises a size and/or diameter greater than a diameter and/or exterior dimension of sleeve adapter 12. Thus, in the embodiment illustrated in FIG. 3, a retaining member 80 is disposed between an interior surface 82 of cover 70 and end 34 of sleeve adapter 12. Retaining member 80 generally comprises an outer dimension and/or diameter configured to be placed and/or otherwise engage at least a portion of interior surface 82 of cover 70 and having an internal opening 90 sized to enable retaining member 80 to slide downwardly over socket 16 while enabling sleeve adapter 12 to engage a surface 92 of retaining member 80, thereby securing cover 70 to light fixture 10 and/or base member 14.

Thus, embodiments of sleeve adapter 12 enable a modification to a light fixture to change the appearance or design of the light fixture top resemble a candlestick. Further, embodiments of sleeve adapter 12 enable installation and/or removal thereof relative to a light fixture with little or no removal and/or disassembly of other portion of then light fixture.

What is claimed is:

1. A light fixture, comprising:
a socket having a set of internal threads for threadably engaging a light unit, the socket having a set of external threads; and
a sleeve adapter configured to resemble a candlestick, the sleeve adapter disposable over the socket and configured to removably engage the set of external threads to secure the sleeve adapter thereto.

2. The light fixture of claim 1, wherein the socket comprises a first end and a second end, and wherein the internal threads and the external threads are disposed at the first end.

3. The light fixture of claim 1, wherein the sleeve adapter comprises a set of internal threads for engaging the external threads.

4. The light fixture of claim 1, wherein the sleeve adapter comprises a set of internal threads configured to threadably engage an end of the socket that engages the light unit.

5. The light fixture of claim 1, wherein the sleeve adapter comprises an elongate sleeve adapter.

6. The light fixture of claim 1, wherein the sleeve adapter is configured to secure a cover to the light fixture.

7. The light fixture of claim 1, wherein the sleeve adapter is configured to secure a cover against a base member of the light fixture.

8. A light fixture, comprising:
a socket configured to have a light unit releasably engaged therewith; and
a sleeve adapter configured to resemble a candlestick, the sleeve adapter disposable over at least a portion of the socket and configured to enable engagement of the light unit with the socket when the sleeve adapter is disposed over the socket, the sleeve adapter readily removable from the socket while the socket remains secured to the light fixture.

9. The light fixture of claim 8, wherein the sleeve adapter is configured to threadably engage the socket.

10. The light fixture of claim 8, wherein the sleeve adapter is configured to secure a cover to the light fixture.

11. The light fixture of claim 8, wherein the sleeve adapter is configured to secure a cover against a base member of the light fixture.

12. The light fixture of claim 8, wherein the sleeve adapter is configured to releasably engage an end of the socket receiving the light unit.

13. A light fixture, comprising:
a socket configured to have a light unit releasably engaged therewith; and
a sleeve adapter resembling a candlestick and configured to be removably disposed over at least a portion of the socket, the sleeve adapter configured to secure a cover to the light fixture.

14. The light fixture of claim 13, wherein the sleeve adapter is configured to releasably engage the socket.

15. The light fixture of claim 13, wherein the sleeve adapter is configured to secure the cover to a base member of the light fixture.

16. The light fixture of claim 13, wherein the sleeve adapter is configured to threadably engage the socket.

17. The light fixture of claim 13, wherein the sleeve adapter is configured to engage an end of the socket receiving the light unit to secure the sleeve adapter to the socket.

18. A sleeve adapter for a light fixture, comprising:
a hollow member configured to resemble a candlestick, the hollow member comprising a set of internal threads for engaging a set of external threads disposed on a socket of the light fixture to releasably secure the sleeve adapter over at least a portion of the socket.

19. The sleeve adapter of claim 18, wherein the hollow member is readily removable from the socket while the socket remains secured to the light fixture.

20. The sleeve adapter of claim 18, wherein the hollow member is configured to secure a cover to the light fixture when the hollow member is secured to the socket.
